(19) United States
(12) Patent Application Publication
(10) Pub. No.: US 2025/0101776 A1
(43) Pub. Date: Mar. 27, 2025

(54) LOCKING MECHANISM FOR CONSOLE DEVICE AND VEHICULAR CONSOLE DEVICE INCLUDING SAME

(71) Applicants: HYUNDAI MOTOR COMPANY, SEOUL (KR); KIA CORPORATION, SEOUL (KR); NIFCO KOREA INC., ASAN-SI (KR)

(72) Inventors: Min-Woo Kwon, Seoul (KR); Jae-Hyun An, Hwaseong-si (KR); Chang-Hoon Yang, Hwaseong-si (KR); Hong-Sik Chang, Hwaseong-si (KR); Sung-Hwan Kim, Incheon (KR); Seung-Mok Yu, Hwaseong-si (KR); Ji-Hun Lee, Asan-si (KR)

(21) Appl. No.: 18/405,471

(22) Filed: Jan. 5, 2024

(30) Foreign Application Priority Data
Sep. 25, 2023 (KR) 10-2023-0127857

(51) Int. Cl. E05B 83/32; B60N 2/75; B60R 7/04

(52) U.S. Cl. CPC E05B 83/32; B60N 2/793; B60R 7/04

(57) ABSTRACT

A locking mechanism for a console device, which restricts a console armrest of the console device disposed between a driver seat and a passenger seat inside a vehicle, includes a housing mounted on a front surface of a console box of the console device, a pivoting lever pivotably coupled to an inner surface of the housing, a slider pivotably coupled to an upper body of the pivoting lever, an inertial member interlocking portion coupled to a lower body of the pivoting lever, an inertial member seating portion which is mounted on the housing and on which an inertial member is seated, and the inertial member provided between the inertial member interlocking portion and the inertial member seating portion and configured to operate the inertial member interlocking portion when a collision of the vehicle occurs.

### CROSS REFERENCE TO RELATED APPLICATIONS

This application claims priority to Korean Patent Application No. 10-2023-0127857, filed on Sep. 25, 2023, which is incorporated herein by reference in its entirety.

### BACKGROUND

### Field of Present Disclosure

Exemplary embodiments of the present disclosure relate to a console device disposed between a driver seat and a passenger seat inside a vehicle, and a locking mechanism applied thereto.

### Description of Related Art

A console device is mounted between a driver seat and a passenger seat inside a vehicle. Generally, the console device includes a console box for storing items and a console armrest made of a cushion material on a cover of an upper portion of the console box so that a user can comfortably place his or her arms on the console device.

In order to open and close the cover, the console armrest is rotatably coupled to a rear portion of the console box by a hinge mechanism, and as the console armrest is pivoted by the hinge mechanism, the cover is moved upward from a front portion of the console armrest so that the upper portion of the console box is opened.

Furthermore, as disclosed in Korean Registered Patent No. 10-0867707, a friction hinge structure for adjusting an opening angle of the console armrest using a friction force may be applied as the hinge mechanism. That is, the friction hinge mechanism of the console armrest includes a shaft and a friction member for generating a friction force by coming into contact with the shaft. Thus, when the shaft is rotated, the console armrest is fixed using the friction force generated by coming into contact with the friction member, and thus the opening angle of the console armrest can be variously adjusted at a desired angle of a user.

In addition, in the console device provided with the friction hinge mechanism, since the console armrest is fixed at a desired position by the friction force, a locking mechanism with a knob at a front portion of the console box is not required.

However, since the conventional console device provided with the friction hinge mechanism does not have a separate locking mechanism, when a collision accident of the vehicle occurs, there is a problem in that the console armrest is pivoted and opened on its own due to an inertial force so that items inside the console box may be separated to the outside or a passenger may be injured due to the opened console armrest.

The contents described in the above Description of Related Art are to aid understanding of the background of the present disclosure and may include what is not previously known to those skilled in the art to which the present disclosure pertains.

### SUMMARY

An embodiment of the present disclosure is directed to providing a locking mechanism for a console device, which can restrict an operation of a console armrest in the event of a forward collision of a vehicle, and a vehicular console device including the same.

Other objects and advantages of the present disclosure can be understood by the following description and become apparent with reference to the embodiments of the present disclosure. Also, it is obvious to those skilled in the art to which the present disclosure pertains that the objects and advantages of the present disclosure can be realized by the means as claimed and combinations thereof.

In accordance with an embodiment of the present disclosure, there is provided a locking mechanism for a console device, which restricts a console armrest of the console device disposed between a driver seat and a passenger seat inside a vehicle, the locking mechanism including a housing mounted on a front surface of a console box of the console device, a pivoting lever pivotably coupled to an inner surface of the housing, a slider pivotably coupled to an upper body of the pivoting lever, an inertial member interlocking portion coupled to a lower body of the pivoting lever, an inertial member seating portion which is mounted on the housing and on which an inertial member is seated, and the inertial member provided between the inertial member interlocking portion and the inertial member seating portion and configured to operate the inertial member interlocking portion when a collision of the vehicle occurs.

In addition, the pivoting lever may be pivotably coupled by a first fastening pin coupled to an intermediate portion of the pivoting lever, and the upper body and lower body may each be formed in a bent shape based on the intermediate portion.

In addition, one end portion of the slider may be pivotably coupled to an end portion of the upper body, and when the pivoting lever is pivoted, the other end portion of the slider passing through a rear surface of the housing may be inserted into the console armrest so that an opening operation of the console armrest may be restricted.

In addition, a seating groove on which the inertial member is seated may be formed in the inertial member seating portion.

In addition, a surface of the inertial member interlocking portion, which supports an upper surface of the inertial member, may be formed as an inclined surface which is inclined from a center to an edge.

Meanwhile, the locking mechanism may further include a first spring having both ends which are coupled to the housing and the pivoting lever.

In addition, a first fastening hole may be formed at the end portion of the upper body of the pivoting lever, a second fastening hole may be formed at the one end portion of the slider, the locking mechanism may further include a fastening pin which passes through the first fastening hole and the second fastening hole to be fastened, and the fastening pin may be fastened while compressing a second spring provided inside the second fastening hole.

In addition, a protruding locking portion may be formed on one side surface of the other end portion of the slider, and when the slider is operated, the locking portion may be caught by the console armrest to restrict the console armrest.

Meanwhile, an inclined protrusion may be inclinedly formed to protrude from the other side surface of the other end portion of the slider and face the inclined portion formed on the console armrest.

Next, in accordance with another embodiment of the present disclosure, there is provided a vehicular console device disposed between a driver seat and a passenger seat inside a vehicle, which includes a console box, a console armrest provided on a cover of the console box, a friction hinge mechanism which is mounted on a rear end portion of the console box to pivotably couple the console armrest to the console box and which includes a friction member, and the locking mechanism.

In addition, the pivoting lever of the locking mechanism may be pivotably coupled by a first fastening pin coupled to an intermediate portion of the pivoting lever, the upper body and lower body may each be formed in a bent shape based on the intermediate portion, and one end portion of the slider may be pivotably coupled to an end portion of the upper body, and when the pivoting lever is pivoted, the other end portion of the slider passing through a rear surface of the housing may be inserted into an armrest groove formed in the console armrest so that an opening operation of the console armrest may be restricted.

In addition, a surface of the inertial member interlocking portion of the locking mechanism, which supports an upper surface of the inertial member, may be formed as an inclined surface which is inclined from a center to an edge.

In addition, a first fastening hole may be formed at the end portion of the upper body of the pivoting lever of the locking mechanism, a second fastening hole may be formed at the one end portion of the slider, the locking mechanism may further include a fastening pin which passes through the first fastening hole and the second fastening hole to be fastened, and in a state in which the fastening pin is fastened while compressing a second spring provided inside the second fastening hole, when the slider is operated, the slider may be inserted into the armrest groove and then moved horizontally due to a restoring force of the second spring.

In addition, a protruding locking portion may be formed on one side surface of the other end portion of the slider of the locking mechanism, and when the slider is operated, the locking portion may be caught by the console armrest to restrict the console armrest.

In addition, an inclined protrusion may be inclinedly formed to protrude from the other side surface of the other end portion of the slider of the locking mechanism, an inclined portion facing the inclined protrusion may be formed at the console armrest, and the slider may be guided by the inclined portion and the inclined protrusion to perform horizontal movement.

### BRIEF DESCRIPTION OF THE FIGURES

FIG. 1 is a diagram illustrating a vehicular console device according to the present disclosure.

FIG. 2 is a diagram illustrating a locking mechanism for a console device according to the present disclosure.

FIG. 3 is an exploded perspective view illustrating the locking mechanism of FIG. 2.

FIG. 4 is a front view illustrating the console device on which the locking mechanism of the present disclosure is mounted.

FIG. 5 is a cross-sectional view taken along line A-A of FIG. 4.

FIG. 6 is a diagram illustrating an operating state of the locking mechanism of the present disclosure based on a cross section A-A of FIG. 4.

FIG. 7 is a cross-sectional view taken along line C-C of FIG. 5.

FIG. 8 is a cross-sectional view taken along line B-B of FIG. 4.

FIGS. 9 and 10 are diagrams illustrating the operating state of the locking mechanism of the present disclosure based on a cross section B-B of FIG. 8.

### DETAILED DESCRIPTION

In order to fully understand the present disclosure and operational advantages of the present disclosure and objects attained by practicing the present disclosure, reference should be made to the accompanying drawings that illustrate exemplary embodiments of the present disclosure and to the description in the accompanying drawings.

In describing exemplary embodiments of the present disclosure, known technologies or repeated descriptions may be reduced or omitted to avoid unnecessarily obscuring the gist of the present disclosure.

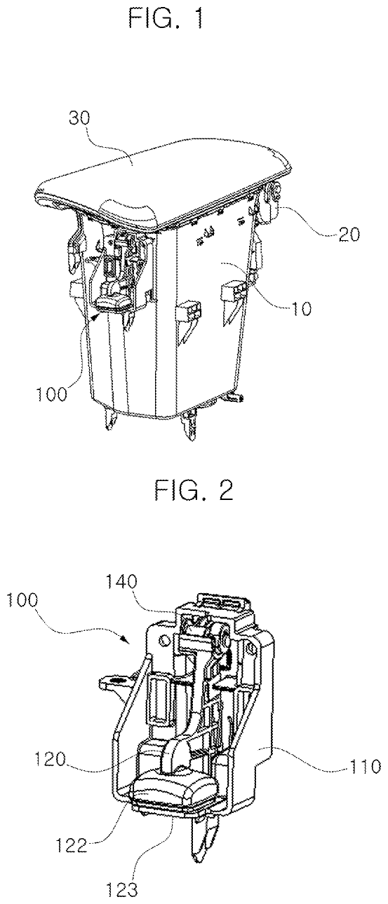

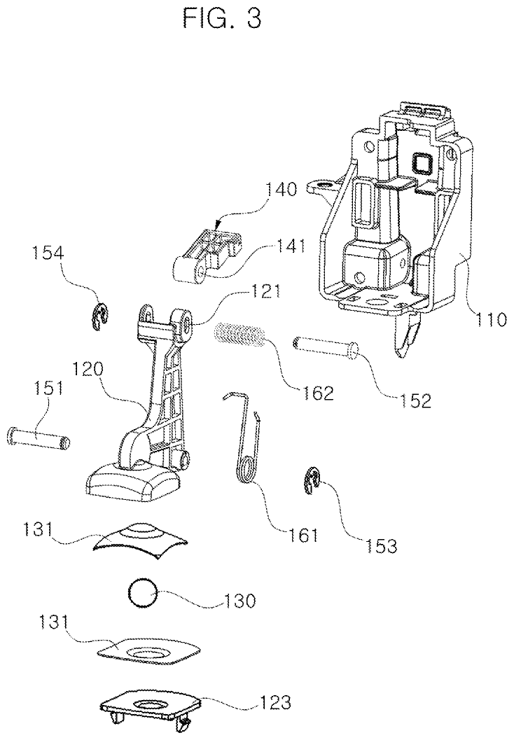

FIG. 1 is a diagram illustrating a vehicular console device according to the present disclosure. In addition, FIG. 2 is a diagram illustrating a locking mechanism for a console device according to the present disclosure, and FIG. 3 is an exploded perspective view illustrating the locking mechanism of FIG. 2.

Hereinafter, the locking mechanism for a console device and a vehicular console device including the same according to one embodiment of the present disclosure will be described with reference to FIGS. 1 to 3.

The present disclosure relates to the console device disposed between a driver seat and a passenger seat inside a vehicle, and the console device includes a console box 10 for storing items, and a console armrest 30 made of a cushion material on a cover of an upper portion of the console box 10 to allow a user to comfortably place his or her arms on the cover.

The console armrest 30 is rotatably coupled to a rear portion of the console box 10 by a hinge mechanism, the hinge mechanism includes a shaft and a friction member configured to apply a friction force to the shaft which is rotated, and thus a friction hinge mechanism 20, which allows the user to adjust an opening angle of the console armrest 30, is applied.

A locking mechanism 100 of the present disclosure is coupled to a front portion of the console box 10 and serves as a G-sensor for restricting the console armrest 30 so as to prevent the console armrest 30 from being opened due to an inertial force when the vehicle receives an external impact.

The locking mechanism 100 includes a housing 110, a pivoting lever 120, an inertial member, and a slider 140.

The pivoting lever 120, the ball 130, and the slider 140 are coupled and embedded in the housing 110, and one surface of the housing 110 is mounted on a front surface of the console box 10.

An intermediate portion of the pivoting lever 120 is coupled to an inner surface of the housing 110 by a first fastening pin 151 to be pivotable about the first fastening pin 151 as a pivoting axis. In this case, a first clip 153 is inserted between the first fastening pin 151 and the pivoting lever 120 to prevent the first fastening pin 151 from being separated. In addition, both ends of a first spring 161 are coupled to the pivoting lever 120 and the housing 110 to minimize a vibration of the pivoting lever 120 due to movement occurring when the vehicle travels on an uneven surface.

The pivoting lever 120 has a shape in which an upper body and a lower body are bent to extend based on the intermediate portion.

The slider 140 is pivotably coupled to an end portion of the upper body. To this end, a first fastening hole 121 is formed at the end portion of the upper body, a second fastening hole 141 is formed at one end portion of the slider 140, a second fastening pin 152 passes through the first fastening hole 121 and the second fastening hole 141, and thus the slider 140 is pivotably coupled to the second fastening pin 152 as the pivoting axis. In this case, a second clip 154 is inserted between the second fastening pin 152 and the pivoting lever 120 to prevent the second fastening pin 152 from being separated.

In addition, the second fastening pin 152 is assembled by passing through a second spring 162 mounted inside the second fastening hole 141, thereby pushing the slider 140 to maintain a locked state in the case of a collision of the vehicle and serving to prevent the locked state from being released due to an impact in the event of a side collision of the vehicle.

In addition, the other end portion of the slider 140 is disposed to pass through a rear surface of the housing 110, and when the pivoting lever 120 performs a pivoting operation about the first fastening pin 151, the slider 140 is pivoted and the other end portion of the slider 140 is moved rearward.

In this case, the other end portion of the slider 140 performing the movement operation is inserted into an armrest groove 31 formed in the console armrest 30, thereby preventing the console armrest 30 from being opened upward when the vehicle receives an external impact.

Next, an inertial member interlocking portion 122, which accommodates an inertial member and is operated by an operation of the inertial member, is mounted on an end portion of the lower body, and an inertial member seating portion 123 on which the inertial member is seated is mounted in the housing 110.

The inertial member is a member that is operated due to inertia in the event of a collision of the vehicle and serves to operate the pivoting lever 120. In one embodiment of the present disclosure, the ball 130 is described as an example of the inertial member, and members in other forms serving as the same inertial member may be employed. A seating groove in which the ball 130 is seated is formed in the center of the inertial member seating portion 123 so that the ball 130 is prevented from being moved beyond the seating groove unless an external force exceeding a predetermined level is applied.

In addition, the inertial member interlocking portion 122 has a lower surface of an upper portion which supports an upper surface of the ball 130 and is formed to be inclined from the center to an edge.

That is, the lower surface of the upper portion of the inertial member interlocking portion 122 is formed with inclined surfaces from the center in all directions or in at least four directions including forward, rearward, left, and right direction, in a length direction and a width direction of the vehicle.

Therefore, when the vehicle receives an external impact, the ball 130 is moved due to an inertial force in a direction in which the inertial force is applied. Thus, as the inertial member interlocking portion 122 is moved upward, the pivoting lever 120 is pivoted about the first fastening pin 151. That is, the ball 130 lowers a G value for operation in the event of a collision.

Thus, the slider 140 is pivoted in a direction opposite to the pivoting lever 120 so that the other end portion of the slider 140 is inserted into the armrest groove 31 of the console armrest 30 to restrict the console armrest 30.

In addition, in order to prevent a noise from being generated by minor movement of the ball 130 as usual, prevention noise pads 131 may be provided between an upper surface of the inertial member seating portion 123 and the ball 130 and between a lower surface of the inertial member interlocking portion 122 and the ball 130.

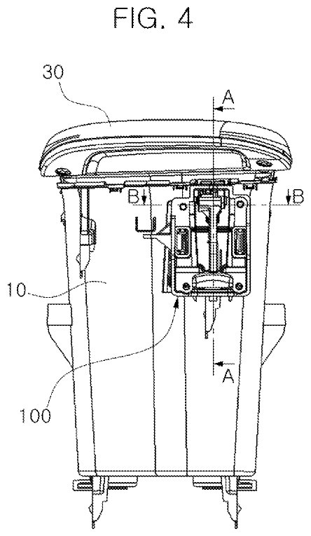

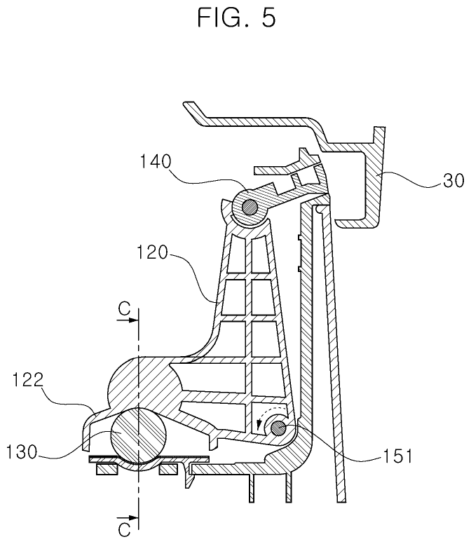

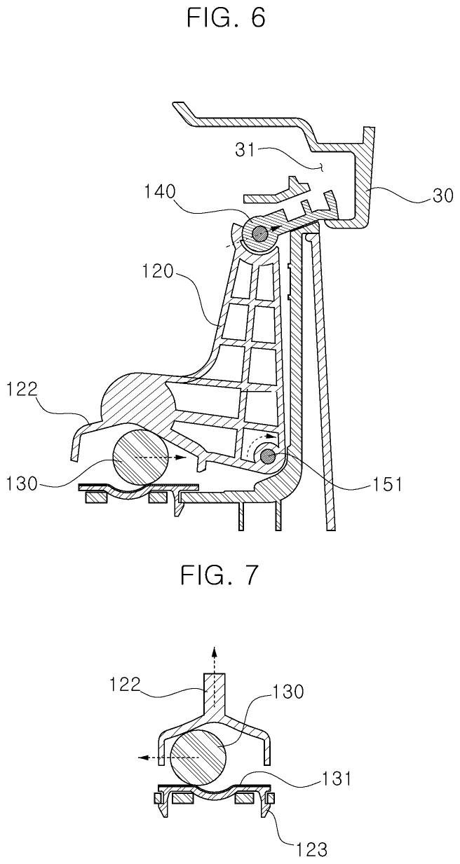

FIG. 4 is a front view illustrating the console device on which the locking mechanism of the present disclosure is mounted, and FIG. 5 is a cross-sectional view taken along line A-A of FIG. 4. In addition, FIG. 6 is a diagram illustrating an operating state of the locking mechanism of the present disclosure based on a cross section A-A of FIG. 4, and FIG. 7 is a cross-sectional view taken along line C-C of FIG. 5.

Hereinafter, an operating state of the locking mechanism 100 of the present disclosure will be described with reference to FIGS. 4 to 7.

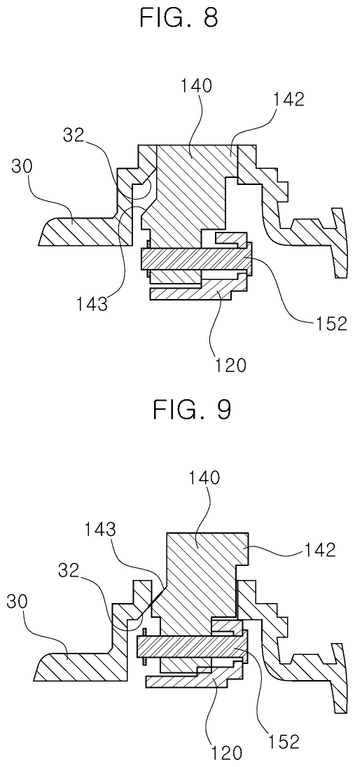

FIG. 5 shows a mounted state in which no collision occurs, and the ball 130 is positioned in a central section between the inertial member interlocking portion 122 and the inertial member seating portion 123. As shown in FIGS. 5 and 8, the slider 140 is not inserted into the armrest groove 31 of the console armrest 30.

FIG. 6 shows a rear collision state of the vehicle. In this case, the ball 130 is separated from a seating groove of the inertial member seating portion 123 to be moved rearward as shown in the drawings.

Thus, the pivoting lever 120 is pivoted in a clockwise direction about the first fastening pin 151, and the slider 140 is pivoted in a counterclockwise direction and is pushed rearward to be inserted into the armrest groove 31.

Therefore, the console armrest 30 is caught by the slider 140 so that the console armrest 30 is prevented from being opened upward even in the event of a collision.

In addition, FIG. 7 shows a left side collision state of the vehicle. In this case, the ball 130 is separated from a seating groove of the inertial member seating portion 123 to be moved leftward as shown in the drawings.

In the present disclosure, due to the shape of the upper surface of the inertial member interlocking portion 122, the pivoting lever 120 operates as shown in FIG. 6, so that the console armrest 30 is caught by the slider 140 and is not opened upward even in the event of a collision.

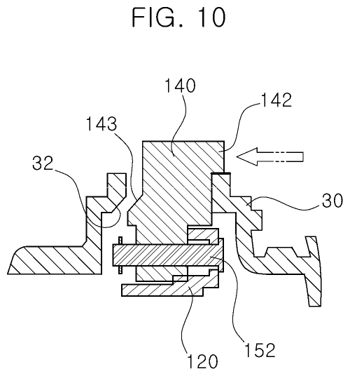

FIGS. 9 and 10 are diagrams illustrating the operating state of the locking mechanism of the present disclosure based on a cross section B-B of FIG. 8.

A protruding locking portion 142 is formed at an end of one side of the slider 140, and an inclined protrusion 143 formed to inclinedly protrude from the other side of the slider 140.

First, in the state of FIG. 8, in a state in which the second spring 162 is compressed, the other end of the slider 140 is mounted on a groove surface of an inlet of the armrest groove 31.

In such a state, when a collision of the vehicle occurs, as the other end of slider 140 is inserted into the armrest groove 31, and the second spring 162 is elastically restored, the slider 140 is moved in a horizontal direction and the locking portion 142 is caught on a rear surface of the groove surface of the inlet of the armrest groove 31 so that the slider 140 remains in a locked state.

Then, by applying an external force in a direction of an arrow as shown in the drawing, the locked state is released, and thus the console armrest 30 may be opened again.

Meanwhile, for smooth insertion of the slider 140, an inclined portion 32 may be formed on the groove surface of the inlet of the armrest groove 31 facing the inclined protrusion 143, and when the slider 140 is inserted, the inclined protrusion 143 is moved along the inclined portion 32 so that the slider 140 is moved smoothly horizontally.

As described above, according to the console device to which the locking mechanism of the present disclosure is applied, even in the friction hinge structure, it is possible to prevent the console armrest from being opened when impacts are applied to the vehicle in all directions including the front, rear, left, and right directions and in a vertical direction.

In accordance with the present disclosure, there is provided a G-sensor structure technology for a friction hinge of a console armrest and provided an improved structure for an internal compartment door, which prevents the console armrest from being opened by rotating the G-sensor faster than the console armrest when a collision of a vehicle occurs.

The G-sensor can be mounted on a front side of a console box separately from the console armrest and can be applied for common use.

Since the conventional friction hinge does not have a separate locking mechanism, the console armrest is opened in the event of a collision so that the conventional friction hinge cannot be applied in an area corresponding to the internal compartment door. However, in accordance with the present disclosure, by applying the G-sensor, it is possible to satisfy the internal compartment door by preventing the console armrest from being opened and to expand an application area of the friction hinge.

In accordance with the present disclosure, not only left, right, and side collisions of the vehicle but also all SLED TEST conditions (all directions including forward, rearward, left, and right directions and a vertical direction of the vehicle) are satisfied so that there are few constraint conditions on satisfying regulations.

While the present disclosure has been described with reference to the accompanying drawings, it will be apparent to those skilled in the art that various changes and modifications can be made without departing from the spirit and scope of the present disclosure without being limited to the exemplary embodiments disclosed herein. Accordingly, it should be noted that such alternations or modifications fall within the claims of the present disclosure, and the scope of the present disclosure should be construed on the basis of the appended claims.

1. A locking mechanism for a console device, being configured to restrict a console armrest of the console device disposed between a driver seat and a passenger seat inside a vehicle, the locking mechanism comprising:
a housing mounted on a front surface of a console box of the console device;
a pivoting lever pivotably coupled to an inner surface of the housing;
a slider pivotably coupled to an upper body of the pivoting lever;
an inertial member interlocking portion coupled to a lower body of the pivoting lever; and
an inertial member seating portion mounted on the housing and on which an inertial member is seated;
wherein the inertial member is positioned between the inertial member interlocking portion and the inertial member seating portion, and wherein the inertial member is configured to operate the inertial member interlocking portion when a collision of the vehicle occurs.

2. The locking mechanism of claim 1, wherein:
the pivoting lever is pivotably coupled by a first fastening pin coupled to an intermediate portion of the pivoting lever; and
the upper body and lower body are each formed in a bent shape based on the intermediate portion.

3. The locking mechanism of claim 2, wherein one end portion of the slider is pivotably coupled to an end portion of the upper body, and when the pivoting lever is pivoted, an other end portion of the slider passing through a rear surface of the housing is inserted into the console armrest to restrict an opening operation of the console armrest.

4. The locking mechanism of claim 3, wherein a seating groove on which the inertial member is seated is formed in the inertial member seating portion.

5. The locking mechanism of claim 4, wherein a surface of the inertial member interlocking portion, which supports an upper surface of the inertial member, is inclined from a center to an edge.

6. The locking mechanism of claim 3, further comprising:
a first spring having a first end coupled to the housing and a second end coupled to the pivoting lever.

7. The locking mechanism of claim 3, wherein:
a first fastening hole is formed at the end portion of the upper body of the pivoting lever, and a second fastening hole is formed at the one end portion of the slider;
the locking mechanism further includes a fastening pin passing through the first fastening hole and the second fastening hole to be fastened; and
the fastening pin is fastened while compressing a second spring positioned inside the second fastening hole.

8. The locking mechanism of claim 7, wherein a protruding locking portion is formed on one side surface of the other end portion of the slider, and when the slider is operated, the locking portion is caught by the console armrest to restrict the console armrest.

9. The locking mechanism of claim 8, wherein an inclined protrusion protrudes from the other side surface of the other end portion of the slider and faces the inclined portion formed on the console armrest.

10. A vehicular console device positioned between a driver seat and a passenger seat inside a vehicle, the vehicular console device comprising:
a console box;
a console armrest provided on a cover of the console box;
a friction hinge mechanism mounted on a rear end portion of the console box to pivotably couple the console armrest to the console box, the friction hinge mechanism including a friction member; and
the locking mechanism according to claim 1.

11. The vehicular console device of claim 10, wherein:
the pivoting lever of the locking mechanism is pivotably coupled by a first fastening pin coupled to an intermediate portion of the pivoting lever; the upper body and lower body are each formed in a bent shape based on the intermediate portion; and
one end portion of the slider is pivotably coupled to an end portion of the upper body, and when the pivoting lever is pivoted, an other end portion of the slider passing through a rear surface of the housing is inserted into an armrest groove formed in the console armrest to restrict an opening operation of the console armrest.

12. The vehicular console device of claim 11, wherein a surface of the inertial member interlocking portion of the locking mechanism, which supports an upper surface of the inertial member, is inclined from a center to an edge.

13. The vehicular console device of claim 12, wherein:
a first fastening hole is formed at the end portion of the upper body of the pivoting lever of the locking mechanism, and a second fastening hole is formed at the one end portion of the slider;
the locking mechanism further includes a fastening pin passing through the first fastening hole and the second fastening hole to be fastened; and
in a state in which the fastening pin is fastened while compressing a second spring provided inside the second fastening hole, when the slider is operated, the slider is inserted into the armrest groove and then moved horizontally due to a restoring force of the second spring.

14. The vehicular console device of claim 13, wherein a protruding locking portion is formed on one side surface of the other end portion of the slider of the locking mechanism, and when the slider is operated, the locking portion is caught by the console armrest to restrict the console armrest.

15. The vehicular console device of claim 14, wherein:
an inclined protrusion protrudes from the other side surface of the other end portion of the slider of the locking mechanism;
an inclined portion facing the inclined protrusion is formed at the console armrest; and
the slider is guided by the inclined portion and the inclined protrusion to perform horizontal movement.
